(19) United States
(12) Patent Application Publication
(10) Pub. No.: US 2010/0296728 A1
(43) Pub. Date: Nov. 25, 2010

(54) Discrimination Apparatus, Method of Discrimination, and Computer Program

(76) Inventor: Shinya OHTANI, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/780,422

(22) Filed: May 14, 2010

(30) Foreign Application Priority Data
May 22, 2009 (JP) P2009-124386

(51) Int. Cl. G06K 9/62; G06K 9/46

(52) U.S. Cl. 382/159; 382/190

(57) ABSTRACT

A discrimination apparatus includes: a feature-quantity extraction section extracting a feature quantity from an object of discrimination; and a discriminator including a plurality of weak discriminators expressed as a Bayesian network having each node to which a corresponding one of two or more of the feature quantities input from the feature-quantity extraction section is allocated and a combiner combining individual discrimination results of the object of discrimination by the plurality of weak discriminators.

### BACKGROUND OF THE INVENTION

1. Field of the Invention

The present invention relates to a discrimination apparatus, method of discrimination, and computer program which makes a discrimination by boosting using a plurality of weak hypotheses individually discriminating an object on the basis of feature quantities of the object, and learns the weak hypotheses by boosting.

2. Description of the Related Art

A learning machine obtained by sample learning includes a lot of weak hypotheses and a combiner combining these hypotheses. Here, as an example of a combiner integrating outputs of weak hypotheses using fixed weights without depending on inputs, “boosting” is provided.

In the boosting, the distribution of learning samples is processed such that a weight of a learning sample not being good at making errors is increased using learning results of weak hypotheses generated before, and the learning of a new weak hypothesis is carried out on the basis of the distribution. Thereby, the weight of a learning sample that produces a lot of incorrect answers and is difficult to be discriminated is relatively increased, and weak discriminators are selected one after another such that a correct answer is given to a learning sample having a heavy weight, that is to say, being difficult to be discriminated. The generation of a weak hypothesis in the learning is carried out one after another, and a weak hypothesis generated later depends on the weak hypotheses generated earlier.

Here, a weak discriminator performing discrimination processing on the basis of weak hypotheses corresponds to a “filter” that outputs a binary determination result from an input using a feature quantity of some kind. In general, when boosting is used as a discriminator, the types of weak hypotheses, which discriminate a threshold value of an extracted feature quantity independently of each dimension, are often used. However, there is a problem in that a lot of weak hypotheses are necessary for producing good performance. Also, the user finds it difficult to obtain the configuration of weak hypotheses after the learning, and thereby readability of learning results is insufficient. Also, the number of weak hypotheses used for discrimination affects the amount of calculation at the time of determination, and thus it is difficult to implement discriminators by hardware having insufficient calculation capacity.

Also, as another example, a proposal has been made of an ensemble learning apparatus which uses weak discriminators as filters discriminating an object using a very simple feature quantity (a difference feature between pixels), namely a difference between luminance values of two reference pixels (for example, refer to Japanese Unexamined Patent Application Publication No. 2005-157679). By that apparatus, it is possible to speed up detection processing of an object while sacrificing recognition performance. However, if an object is difficult to be linearly discriminated by the difference, the object fails to be classified by weak hypotheses.

### SUMMARY OF THE INVENTION

It is desirable to provide an excellent discrimination apparatus, method of discrimination, and computer program which preferably makes a discrimination by boosting using a plurality of weak hypotheses individually discriminating an object on the basis of feature quantities of the object, and allows preferable learning of the individual weak hypotheses by boosting.

It is also desirable to provide an excellent discrimination apparatus, method of discrimination, and computer program that can improve discrimination performance while reducing the number of weak hypotheses to be used.

It is further desirable to provide an excellent discrimination apparatus, a method of discrimination, and a computer program which can shorten learning time, reduce the amount of calculation at discrimination time, and achieve improvement in readability of a learning result by reducing the number of weak hypotheses to be used.

According to an embodiment of the present invention, there is provided a discrimination apparatus including: a feature-quantity extraction section extracting a feature quantity from an object of discrimination; and a discriminator including a plurality of weak discriminators expressed as a Bayesian network having each node to which a corresponding one of two or more of the feature quantities input from the feature-quantity extraction section is allocated and a combiner combining individual discrimination results of the object of discrimination by the plurality of weak discriminators.

In the above-described embodiment, the discriminator may use an inference probability of a discrimination-target node of the Bayesian network with weak-hypotheses as an output of the weak hypotheses.

In the above-described embodiment, BOW (Bag Of Words) or other high-dimensional feature-quantity vectors may be used for the object of discrimination, and the weak discriminator may include a Bayesian network having the feature quantity of a predetermined number of dimensions or less as each node out of high-dimensional feature-quantity vectors extracted by the feature-quantity extraction section.

In the above-described embodiment, a text may be included in the object of discrimination, and the discriminator may carry out binary discrimination on whether an opinion sentence or the other kinds of text.

In the above-described embodiment, on the basis of whether an inference probability of a discrimination-target node of the weak-hypothesis Bayesian network is greater than a predetermined value, the discriminator may determine an error of the weak hypothesis.

The discrimination apparatus according to the above-described embodiment may further include a learning section learning weak hypotheses to be used by the plurality of weak discriminators, respectively, and weight information of the individual weak hypotheses by prior learning using boosting.

In the above-described embodiment, the learning section may reduce a number of weak-hypothesis candidates by limiting a number of feature-quantity dimensions used by one weak hypothesis.

In the above-described embodiment, the learning section may calculate an evaluation value of one-dimensional weak hypothesis of each dimension on the assumption that a number of feature-quantity dimensions used for one weak hypothesis is 1, and may create a weak hypothesis candidate by combining necessary number of feature-quantity dimensions for a weak hypothesis in descending order of the evaluation value of the dimension.

Also, according to another embodiment of the present invention, there is provided a method of discrimination, including the steps of: extracting a feature quantity from an object of discrimination; and discriminating the object of discrimination by a plurality of weak hypotheses expressed as a Bayesian network having each node to which a corresponding one of two or more of the feature quantities obtained by the step of extracting a feature quantity is allocated, and combining individual discrimination results of the object of discrimination by the plurality of weak hypotheses.

Also, according to another embodiment of the present invention, there is provided a computer program causing a computer to function as a discrimination apparatus including: a feature-quantity extraction section extracting a feature quantity from an object of discrimination; and a discriminator including a plurality of weak discriminators expressed as a Bayesian network having each node to which a corresponding one of two or more of the feature quantities input from the feature-quantity extraction section is allocated and a combiner combining individual discrimination results of the object of discrimination by the plurality of weak discriminators.

The above-described computer program is a computer program described in a computer-readable format in order to achieve predetermined processing on a computer. To put it differently, by installing the above-described computer program in a computer, it is possible to obtain the same advantages as the above-described discrimination apparatus on the basis of the coordinated operation.

By the present invention, it is possible to provide an excellent discrimination apparatus, method of discrimination, and computer program which preferably makes a discrimination by boosting using a plurality of weak hypotheses individually discriminating an object on the basis of feature quantities of the object, and allows preferable learning of the individual weak hypotheses by boosting.

Also, by the present invention, it is possible to provide an excellent discrimination apparatus, method of discrimination, and computer program which can improve discrimination performance while reducing the number of weak hypotheses to be used.

Also, by the present invention, it is possible to provide an excellent discrimination apparatus, a method of discrimination, and a computer program which can shorten learning time, reduce the amount of calculation at discrimination time, and achieve improvement in readability of a learning result by reducing the number of weak hypotheses to be used.

In general weak hypotheses, individual dimensions of a feature quantity are independently subjected to threshold-value discrimination, and it is difficult to achieve good performance unless a lot of weak hypotheses are used. Also, with the use of a lot of weak hypotheses, it becomes difficult for the user to grasp the configuration of the weak hypotheses after learning. In contrast, by the above-described embodiments of the present invention, a Bayesian network (BN) is used as weak hypotheses, and an inference is made using BN weak hypotheses by inputting learning samples. Accordingly, the feature quantities of an object of discrimination are compared with a plurality of discriminant surfaces corresponding to individual dimensions of the feature quantities, respectively, so that high performance can be obtained. Also, by the present invention, it is possible to produce good results in reducing the number of weak hypotheses in boosting using BN weak hypotheses, and in improving readability of learning results.

By an embodiment of the present invention, the inference probability of discrimination-target nodes of weak-hypothesis Bayesian network is used as an output of the weak hypothesis, and the individual discrimination results of a discrimination object by a plurality of weak discriminators are combined so that discrimination performance can be improved while reducing the number of weak hypotheses to be used.

By an embodiment of the present invention, the number of dimensions of the feature-quantity nodes of a weak-hypothesis Bayesian network is limited so that learning time can be reduce, the amount of calculation at discrimination time can be reduced, and improvement in the readability of learning results can be achieved.

By an embodiment of the present invention, a text can be included in the object of discrimination, and binary discrimination on whether an opinion sentence or the other kinds of text can be carried out.

By an embodiment of the present invention, on the basis of whether an inference probability of a discrimination-target node of a weak-hypothesis Bayesian network is greater than a predetermined value, the discriminator can determine an error of the weak hypothesis.

By an embodiment of the present invention, the learning section can shorten learning time, and can improve the readability of learning results by reducing the number of weak hypotheses to be used.

By an embodiment of the present invention, the number of dimensions of feature quantities used by one weak hypothesis is limited, and thus the number of weak-hypothesis candidates to be evaluated is reduced. Thereby, the learning time can be shortened.

By an embodiment of the present invention, an evaluation value of one-dimensional weak hypothesis of each dimension is calculated on the assumption that a number of feature-quantity dimensions used for one weak hypothesis is 1, and a weak-hypothesis candidate is created by combining a necessary number of feature-quantity dimensions for a weak hypothesis in descending order of evaluation value of the dimension. Thereby, the number of weak-hypothesis candidates to be evaluated can be reduced, and the learning time can be shortened.

The above described and other problems to be addressed, and the features and advantages of the present invention will become apparent by the below-described embodiment of the present invention and the detailed description thereof with reference to the accompanying figures.

### BRIEF DESCRIPTION OF THE DRAWINGS

FIG. 1 is a schematic diagram illustrating a configuration of a text-discrimination apparatus 10;

FIG. 2 is a schematic diagram illustrating an internal configuration of the discriminator 13;

FIG. 3 is a diagram illustrating an example of a configuration of a Bayesian network expressing weak hypotheses for discriminating an opinion sentence;

FIG. 4 is a flowchart illustrating a processing procedure for learning weak discriminators using a Bayesian network as weak hypotheses using boosting;

FIG. 5A is a diagram illustrating examples of a Bayesian network as weak hypotheses;

FIG. 5B is a diagram illustrating examples of a Bayesian network as weak hypotheses;

FIG. 6 is a flowchart illustrating a processing procedure for discriminating an opinion sentence using boosting with a Bayesian network as weak hypotheses;

FIG. 7 is a diagram illustrating a relationship between the number of weak hypotheses and performance (performance of boosting with a Bayesian network including two feature-quantity nodes and one feature-quantity node, that is to say, three nodes in total) in the case of applying the present invention to text discrimination;

FIG. 8 is a flowchart illustrating a processing procedure for reducing the number of BN weak hypotheses without substantially decreasing the evaluation value of BN-weak-hypothesis candidate having the best evaluation among BN-weak-hypothesis candidates;

FIG. 9A is a diagram illustrating a processing procedure for reducing the number of BN weak hypotheses without substantially decreasing the evaluation value of BN-weak-hypothesis candidate having the best evaluation among BN-weak-hypothesis candidates;

FIG. 9B is a diagram illustrating a processing procedure for reducing the number of BN weak hypotheses without substantially decreasing the evaluation value of BN-weak-hypothesis candidate having the best evaluation among BN weak hypothesis candidates;

FIG. 10A is a diagram for explaining performance of a discrimination method by weak hypotheses with one-dimensional feature quantity;

FIG. 10B is a diagram for explaining performance of a discrimination method using a Bayesian network as weak hypotheses;

FIG. 10C is a diagram for explaining performance of a discrimination method using a feature-quantity difference as weak hypotheses;

FIG. 11 is a schematic diagram illustrating an example of a configuration of a system to which opinion-sentence discrimination is applied; and

FIG. 12 is a diagram illustrating an example of a configuration of an information apparatus.

### DESCRIPTION OF THE PREFERRED EMBODIMENTS

In the following, a detailed description will be given of an embodiment in which the present invention is applied to text discrimination with reference to the drawings.

As an example of text discrimination, it is possible to give “opinion-sentence discrimination”, which discriminates whether an input sentence is an opinion sentence or not. The opinion sentence is a sentence including an idea held on a certain thing. The opinion sentence often includes individual preference in the form of “opinion” emphatically. For example, a sentence “I like the Checkers.” includes an individual opinion, “like”, so that this sentence is an “opinion sentence”. On the other hand, a sentence “The concert will be held on December 2nd.” is a sentence stating only a fact without including an individual opinion, and thus is a “non-opinion sentence”.

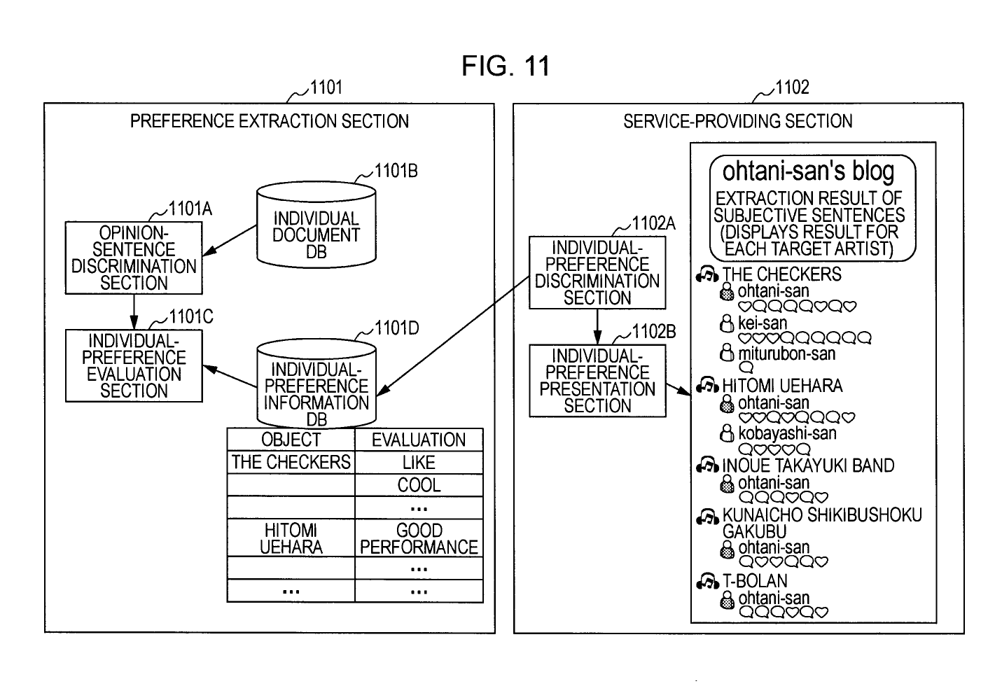

FIG. 11 schematically illustrates an example of a configuration of a system to which opinion-sentence discrimination is applied. The system shown in the figure includes a preference extraction section which extracts preference information from a sentence written by an individual, and a service providing section which provides services, such as preference presentation on the basis of individual preference information.

In the preference extraction section 1101, an opinion-sentence discrimination section 1101A takes out a sentence written by an individual from an individual document database 1101B one by one, discriminates whether an opinion sentence or not, and extracts only a sentence including a strong sense of opinion. And an individual-preference evaluation section 1101C evaluates and extracts an object, and stores preference in an individual-preference information database 1101D as individual preference information one after another.

On the other hand, the service providing section 1102 presents individual preference as an example. An individual-preference discrimination section 1102A discriminates each entry stored in the individual-preference information database 1101D, and determines whether positive or negative. And an individual-preference presentation section 1102B displays a mark in accordance with the number of entries of preference, for example, as a result of subjective-sentence extraction from an individual blog.

It may be said that discriminating opinion sentences is effective as pre-processing extracting individual preference from a lot of sentences written by an individual, such as a diary, a blog, etc. Also, preference information extracted from a sentence written by an individual is not only used for functioning as classification and presentation (feedback) of the individual preference, and functioning as recommendation of purchasing a content, goods, etc., but also for expanding to various kinds of businesses. It is obvious that if discrimination performance of an opinion sentence to be used for pre-processing is improved, correct preference presentation and accurate recommendation of a content can be obtained.

The opinion-sentence discrimination section 1101A includes a discriminator B which outputs an opinion-sentence discrimination result t of an input sentence s. The discriminator B can be expressed by the following expression (1). Note that an output t is “1” if an input sentence is an opinion sentence. Whereas, the output t is “−1” if the input sentence is a non-opinion sentence.

t=B(s)

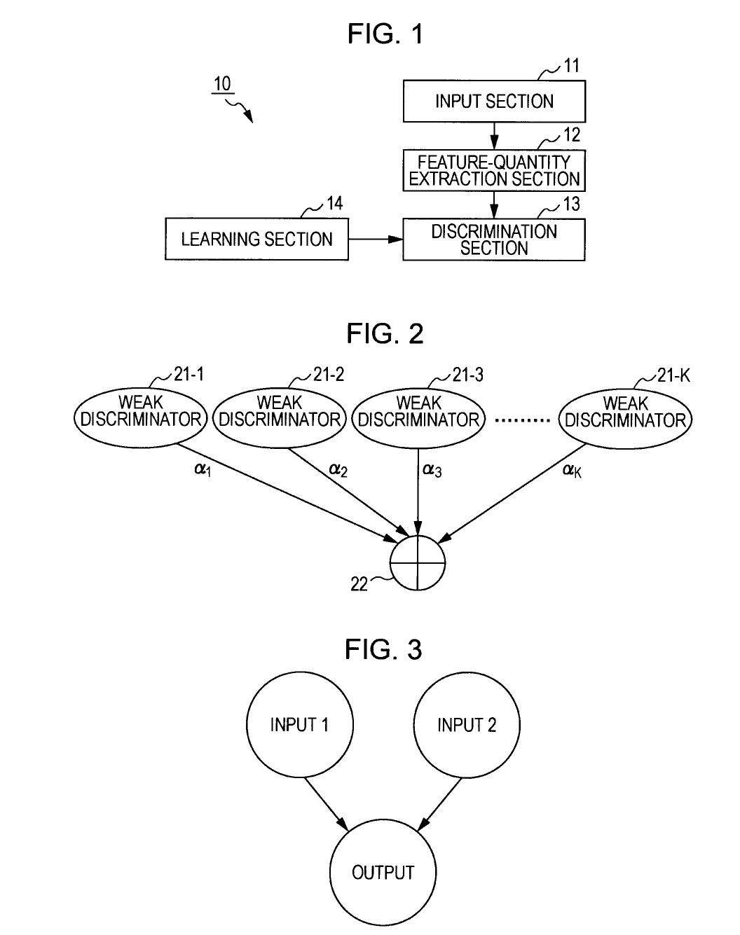

FIG. 1 schematically illustrates a configuration of a text-discrimination apparatus 10, which operates as the discriminator B. The text discrimination apparatus 10 includes an input section 11 receiving input of a text to be an object of discrimination for each sentence, a feature-quantity extraction section 12 extracting feature quantities of the input sentence, a discriminator 13 determining whether the input sentence is an opinion sentence or not on the basis of the feature quantity held by the input sentence, and a learning section 14 carrying out prior learning of the discriminator 13.

The input section 11 captures an input sentence s from a learning sample at learning time, and from an object of discrimination, such as a diary, blog, etc., at discrimination time for each sentence. Next, the feature-quantity extraction section 12 extracts one or more feature quantities f from the input sentence s, and supplies the feature quantities to the discriminator 13. The feature-quantity extraction section 12 outputs a feature quantity vector having information on the frequency of appearances counted in an input sentence for each (phonetic, syntactic, or semantic) characteristic of a word or for each word as an element of dimension.

In the present invention, boosting is used in order to integrate outputs of the weak hypotheses as the discriminator 13. FIG. 2 schematically illustrates an internal configuration of the discriminator 13. The discriminator 13 shown in the figure includes a plurality of weak discriminators 21-1, 21-2, . . . , and a combiner 22. In the case of Adaboost, the combiner includes an adder obtaining a weighted majority decision by multiplying the outputs of individual weak discriminators and the individual weights.

Each of the weak discriminators 21-1 . . . has a corresponding one of the weak hypotheses determining whether the input sentence s is an opinion sentence or a non-opinion sentence on the basis of d-dimensional feature quantities f⁽¹⁾, f⁽²⁾, . . . , and f^{(d)} (that is to say, a d-dimensional feature quantity vector) held by the input sentence s. Each of the weak discriminators 21-1 . . . checks the feature quantity vector supplied from the feature quantity extraction section 12 (described before) with each of the own weak hypotheses, and outputs an estimated value of whether the input sentence s is an opinion sentence or not. And the adder 22 calculates the weighted majority decision B(s) of these weak discrimination results, and outputs it as a discrimination result t of the discriminator 13.

The weak discriminators (or the weak hypotheses used by the weak discriminators) 21-1 . . . used for the opinion sentence discrimination and the weights to be multiplied by the individual weak discriminators 21-1 . . . are obtained by prior learning carried out by the learning section 14 using the boosting.

At the time of learning weak hypotheses, a plurality of sentences are used as learning samples having been subjected to discrimination between two classes, namely whether an opinion sentence or a non-opinion sentence, that is to say, having been subjected to labeling, and a feature quantity vector extracted by the feature-quantity extraction section 12 for each learning sample are input into the individual weak discriminators 21-1 . . . . And the weak discriminators 21-1 . . . have learnt weak hypotheses on the individual feature quantities of an opinion sentence and a non-opinion sentence beforehand. That is to say, weak hypotheses have been generated one after another by learning using the learning samples. In a process of such learning, the weights of a weighted majority decision in accordance with the reliabilities on the individual weak hypotheses are learnt. Although each of the weak discriminators 21-1 . . . has not a high discrimination ability, the discriminator 13 having a high discrimination ability on the whole is built as a result by combining a plurality of the weak discriminators 21-1 . . . .

On the other hand, at the time of discrimination, the individual weak discriminators 21-1 . . . compare the feature quantities held by the input sentence s with the weak hypotheses learnt beforehand, and determinately or probabilistically outputs an estimated value of whether the input sentence is an opinion sentence or not. The adder 22 in the subsequent stage multiplies the estimated values output from the individual weak discriminators 21-1 . . . and the weights αₗ . . . corresponding to the reliabilities of the individual weak discriminators 21-1 . . . , respectively, and outputs a weighted majority-decision value.

As described above, boosting, which integrates the outputs of a plurality of weak hypotheses, is used. The present invention has one of the features in that a Bayesian network (BN) is used as weak hypotheses.

Here, a Bayesian network is a network (also called a probabilistic network or a casual network) formed to have a set of random variables as nodes. A Bayesian network is one of graphical models describing a cause-and-effect relationship with probabilities by connecting a pair of nodes directly affecting (for example, an arrow from a node X to a node Y indicates that X directly affects Y). However, the network is a directed acyclic graph (DAG), which does not have a cycle in the arrow direction. Also, each node has a conditional probability distribution in which the influence of a parent node (a root of an arrow) on the node of interest is quantified. A Bayesian network is an expression format widely used for inference problems under uncertain circumstances (common knowledge).

When opinion sentence discrimination is performed on a text, it is thought that a feature quantity of one or more-than-one dimensions extracted from the input sentence s may directly affect the opinion-sentence discrimination result of the input sentence s, direct effects may occur between feature quantities having different dimensions, the opinion-sentence discrimination result may directly affect a feature quantity having a specific dimension. Accordingly, the weak hypotheses for discriminating an opinion sentence can be expressed by a Bayesian network using feature quantities having a predetermined number of dimensions and the opinion-sentence discrimination result of an input sentence s as input nodes, and using a node to be discriminated as an output node, and by connecting a pair of nodes directly affecting with an arrow. And the inference probability of the nodes to be discriminated of the weak-hypotheses Bayesian network is determined to be the output of the weak-hypotheses. Also, it is possible to discriminate an error of the weak-hypotheses depending on whether the inference probability of the nodes to be discriminated of the weak-hypotheses Bayesian network is greater than a certain value or not.

In the following, a node corresponding to a feature quantity is called a “feature-quantity node”, and a node corresponding to an opinion-sentence discrimination result is called an “output node”. A weak hypothesis expressed by a directed acyclic graph of the feature-quantity nodes and an output node is also called a “BN weak hypothesis”.

A BN weak hypothesis has two kinds of parameters, threshold values of individual feature-quantity nodes and a conditional probability distribution necessary for the probability estimation of the output node when values are input into all the feature-quantity nodes. These parameters are necessary for calculating an estimation value of the BN weak hypothesis.

FIG. 3 illustrates an example of a configuration of a Bayesian network expressing weak hypotheses for discriminating an opinion sentence. In the example shown in the figure, the Bayesian network includes three nodes, namely, a two-dimensional feature-quantity node (input1, input2) and an output node (output) of the discrimination result t. The individual feature-quantity nodes are connected to the output node, which is a discrimination result of the BN weak hypotheses, by an arrow, as parent nodes directly affecting the output node.

And the BN weak hypotheses, shown in the figure, have two kinds of parameters, namely, threshold values of individual feature-quantity nodes and the conditional probability distribution necessary for probability estimation of the output node when values are input into all the feature-quantity nodes. If the individual feature-quantity nodes (input1, input2) as input nodes are binary discrete nodes, the threshold values of the individual feature-quantity nodes can be described as Table 1 below. Also, if the individual feature-quantity nodes are discrete nodes, the conditional probability distribution necessary for output-node probability estimation can be described as a conditional probability table as shown in Table 2 below.

TABLE 1

| | threshold value |
|---|---|
| input1 | 30.134 |
| input2 | −0.74 |

TABLE 2

| input1 | input2 | opinion sentence | non-opinion sentence |
|---|---|---|---|
| under | under | 0.2 | 0.8 |
| under | over | 0.3 | 0.7 |
| over | under | 0.1 | 0.9 |
| over | over | 0.7 | 0.3 |

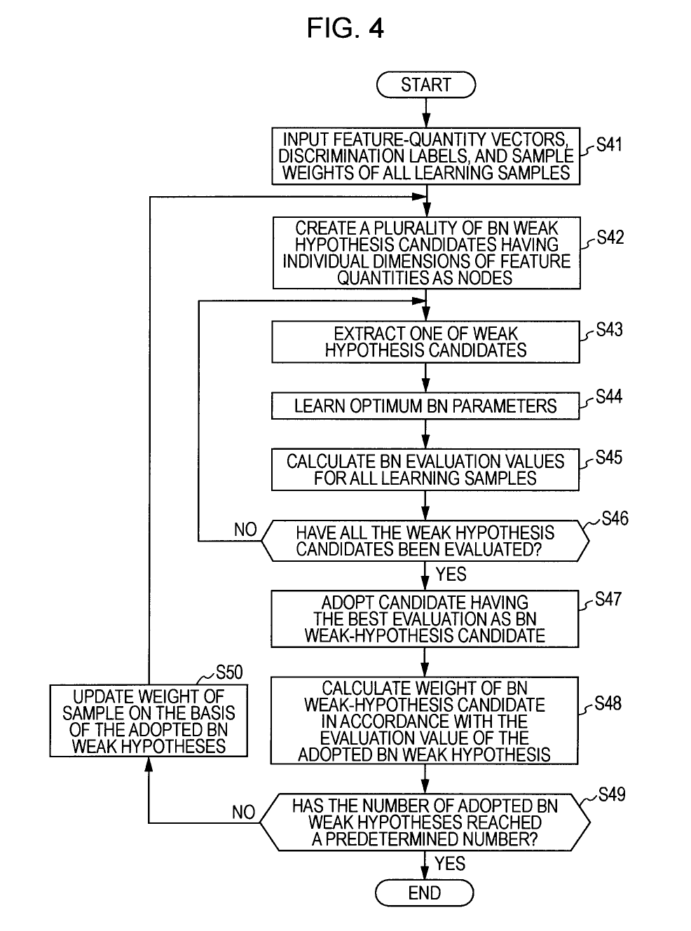

FIG. 4 illustrates, as a flowchart, a processing procedure for learning weak discriminators using a Bayesian network as weak hypotheses using boosting. In the following, a detailed description will be given of a method of learning in boosting using a Bayesian network as weak hypotheses in the learning section 14 with reference to the figure.

The feature quantity extraction section 12 outputs a feature quantity vector having information of the frequency of appearances counted in an input sentence for each (phonetic, syntactic, or semantic) characteristic of a word or for each word as an element of dimension. In the following, it is assumed that the feature-quantity extraction section 12 extracts d feature quantities fₖ⁽¹⁾, fₖ⁽²⁾, . . . , fₖ^{(d)}, that is to say, a d-dimensional feature quantity vector ε (sₖ) expressed by the following expression (2) from the k-th input sentence sₖ.

ε(sₖ)=[fₖ⁽¹⁾, fₖ⁽²⁾, . . . , fₖ^{(d)}]=fₖ (2)

The feature quantity extraction section 12 can extract feature quantities on the basis of, for example, a morphological analysis result of an input sentence. More specifically, a feature quantity vector is a frequency of appearances of a registered word, a frequency of appearances of part of speech, a bi-gram thereof, etc. Also, the feature quantity extraction section 12 can handle any other feature quantities that can be normally used in natural language processing, and can arrange the feature quantities in parallel for using them at the same time.

At the time of boosting learning, the feature-quantity extraction section 12 extracts feature-quantity vectors from all the learning samples T. A discrimination label y for discriminating the two class is attached to each of the learning samples T (if the k-th sentence learning sample sₖ is an opinion sentence, yₖ=1, and if it is a non-opinion sentence, yₖ=−1). Assuming that the total number of sentences of the learning samples T is m, the learning samples T after the feature-quantity extraction section 12 has extracted feature quantities can be expressed by the following expression (3).

$$T = [ \begin{matrix}[ {f}_{1} , {y}_{1} ] \\ [ {f}_{2} , {y}_{2} ] \\ ⋮ \\ [ {f}_{m} , {y}_{m} ]\end{matrix} ] \qquad ( 3 )$$

Also, a sample weight wₖ reflecting the difficulty level, etc., at the time of discriminating an opinion sentence is added to each sample sₖ included in the learning samples T. The learning samples T after extracting feature quantities, that is to say, a feature vector fₖ and a discrimination label yₖ for each sample sₖ, together with a sample weight wₖ are input (step S41).

Next, a plurality of BN weak hypothesis candidates (hereinafter referred to as a “BN weak hypothesis candidates”) having individual dimensions of feature quantities as nodes, which are used for weak discriminators 21-1 . . . , are created (step S42).

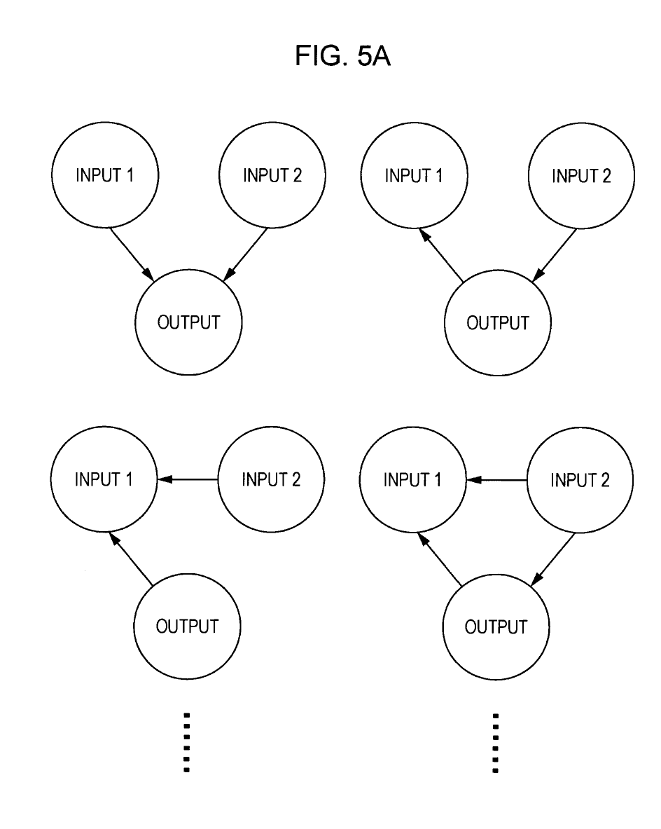

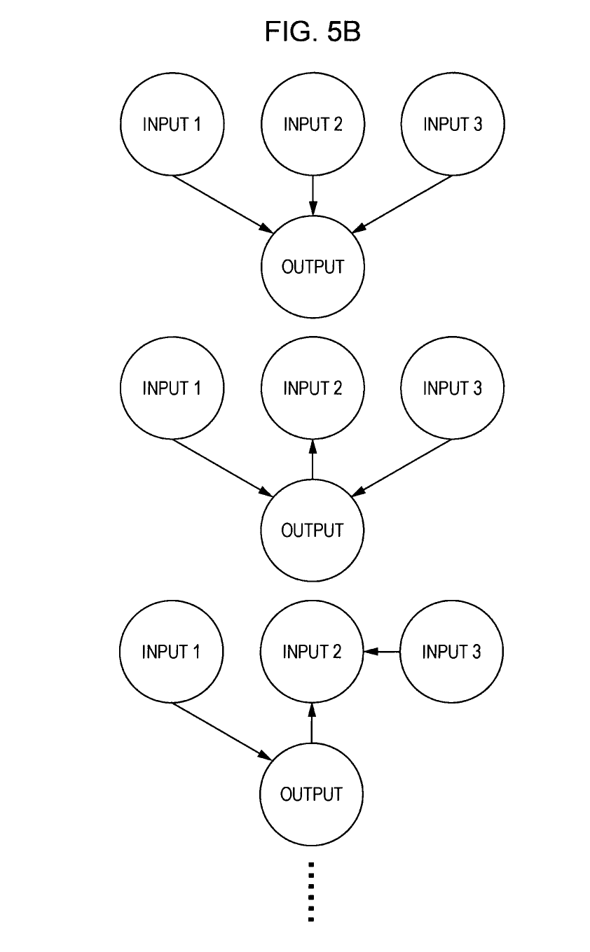

As described above, a BN weak hypothesis includes a “feature-quantity node” having an input of feature quantity having one or more than one dimension as an input node, and an opinion-sentence discrimination result as an “output node”, and is expressed by a Bayesian network connecting a pair of nodes directly affecting by an arrow (refer to FIG. 3). In step S42, Bayesian networks with all the structures may simply be created as BN-weak-hypothesis candidates. However, as shown in FIG. 5A, a plurality of kinds of directed acyclic graph (DAG) are given as Bayesian networks using two-dimensional feature quantities. It can be thought that there are _{d}C₂ BN-weak hypothesis candidates in accordance with the combination of feature quantities to be a parent node for each graph. In the same manner, as shown in FIG. 5B, a plurality of kinds of directed acyclic graph (DAG) are given as Bayesian networks using three-dimensional feature quantities. It can be thought that there are _{d}C₃ BN-weak hypothesis candidates in accordance with the combination of feature quantities to be a parent node for each graph. In short, the total number of BN weak-hypothesis candidates with n nodes becomes a huge number as shown by the following Expression (4). Thus, it is not realistic to evaluate all the structures as BN weak-hypothesis candidates in terms of calculation cost, etc.

$${2}^{\frac{1}{2} {( n - 1 )}^{2}} ∼ n ! \cdot {2}^{\frac{1}{2} {( n - 1 )}^{2}} \qquad ( 4 )$$

Accordingly, in step S42, not all the structures are used as BN-weak-hypothesis candidates, and the number of candidates of the BN weak hypotheses has been reduced to L. As a method of reducing the number of candidates, there is for example, a method of limiting the number of dimensions of feature quantities to be used in one Bayesian network (as shown in FIG. 5A, the number of dimensions is 2, or as shown in FIG. 5B, the number of dimensions is 3), and a method of simply creating only L Bayesian networks. Also, it is possible to reduce the number of candidates of BN weak hypotheses by providing only L network structures allowing to express a learning sample more correctly using a structural learning algorithm (common knowledge), such as K2, PC, etc. In the following, for the sake of convenience, a description will be given on the assumption that a network structure is limited to only one kind that is shown at the leftmost on the page space in FIG. 5A, and L=_{d}C₂ (=d(d−1)/2) BN-weak-hypothesis candidates are used.

Roughly speaking, a method of learning BN weak hypotheses is performing processing loop including the learning (step S44) of optimum parameters for each BN-weak-hypothesis candidate, the calculation (step S45) of an estimation value using the learning sample T, and the calculation of a sample weight (step S50) for the number of times corresponding to the number of necessary BN weak hypotheses. In the processing loop of each time, a BN-weak-hypothesis candidate having the best performance is selected in sequence on the basis of the calculated evaluation value.

One of the L BN-weak-hypothesis candidates created in step S42 is extracted (step S43), and then, first, the optimum parameters are learnt on the extracted BN-weak-hypothesis candidate (step S44).

As described above, in the case of BN weak hypotheses, the parameters necessary for calculating an estimation value are two kinds of parameters, namely the threshold values of individual feature-quantity nodes and a conditional probability distribution necessary for probability estimation when values are input into all the feature-quantity nodes. In the same manner as general boosting, these parameters are obtained such that the estimation value of the BN-weak-hypothesis candidates becomes the maximum. The threshold values of the individual feature-quantity nodes can be obtained by performing full-search on the combinations of all the feature-quantity nodes for an optimum combination. Also, the conditional probability distribution can be obtained using a general BN-conditional-probability distribution algorithm.

Next, the evaluation values are calculated on all the learning samples for the BN-weak-hypothesis candidate after learning the parameters (step S45).

In order to select a weak hypothesis candidate h* having the best performance from L weak-hypothesis candidates H {h₁, h₂, . . . , h_{L}} as shown in the following expression (5) in boosting, it is necessary to calculate an estimation value E(h) as expressed by the following expression (6) for each weak hypothesis candidate hₗ. Note that in the following expression, hₗ denotes a first weak hypothesis candidate, and l is a positive integer less than L.

$$\begin{matrix}H = \{ {h}_{1} , {h}_{2} , … , {h}_{L} \} & ( 5 ) \\ {h}^{*} = arg {max}_{{h}_{l}} ( {E}_{T , {w}^{s}} ( {h}_{l} ) ) & ( 6 )\end{matrix}$$

In the case of general boosting, as shown in the following expression (7), all the learning samples T are input into a weak-hypothesis candidate hₗ, and the total value of sample weights wₖ^{s} of the sample sₖ whose output t is equal to the label yₖ, etc., (to put it another way, whether an opinion sentence or not has been correctly discriminated) is used for the estimation value E (hₗ) of the weak-hypothesis candidate hₗ.

$${E}_{T , {w}^{s}}^{type 1} ( {h}_{l} ) = {\sum }_{k = 1}^{m} {w}_{k}^{s} \cdot {1}_{( {h}_{l} ( {f}_{k} ) = {y}_{k} )} \qquad ( 7 )$$

In general weak hypothesis hₗ^{g}, an output is calculated using only one-dimensional feature out of d-dimensional feature quantities. As shown in the following expression (8), the output of a general weak hypothesis hₗ^{g} is determined by whether the value produced from the multiplication of the feature quantity fₖ, which is an input value, and a sign vₗ* is greater than a threshold value θₗ*.

hₗ^{g}(fₖ)=hₗ^{g}(fₖ^{jl})=sgn(vₗ*·fₖ^{jl}−θₗ*) (8)

Note that the sign v* and the threshold value θ*, used in the above expression (8), are obtained independently for each weak hypothesis candidate hₗ^{g} before the calculation of the estimation value such that the estimation value E (hₗ^{g}) of general weak-hypothesis candidate hₗ^{g} becomes a maximum as shown in the following expression (9).

$$\{ {v}_{l}^{*} , {θ}_{l}^{*} \} = arg {max}_{\{ {v}_{l} , {θ}_{l} \}} ( {E}_{T , {w}^{s}} ( {h}_{l}^{g} ) ) \qquad ( 9 )$$

In general weak hypotheses, individual dimensions of feature quantities are subjected to threshold-value discrimination, and thus it is difficult to produce good performance without using a lot of weak hypotheses. Also, with the use of a lot of weak hypotheses, it becomes difficult for the user to grasp the configuration of weak hypotheses after the learning. Also, it is difficult to implement discriminators by hardware having insufficient calculation capacity.

In contrast, in the present invention, a Bayesian network (BN) is used as weak hypotheses, and an inference is made using BN weak hypotheses with input of learning samples. Specifically, as shown in the following expression (10), the feature quantity vector fₖ of the k-th sample sₖ is input, and an event (an opinion sentence or a non-opinion sentence) having a highest inference probability Pₕₗ (tₖ|fₖ) of the node (output) allocated to a discrimination result tₖ is determined to be the output of the BN weak hypotheses candidate hₗ^{BN}. In such a case, in the same manner as above-described general algorithm, it is possible to calculate an estimation value E (hₗ^{BN}) of each BN-weak-hypothesis candidate hₗ^{BN} using the above expression (7).

$${h}_{l}^{BN} ( {f}_{k} ) = {arg max}_{{t}_{k}} {P}_{{h}_{l}} ( {t}_{k} \vert {f}_{k} ) \qquad ( 10 )$$

In this regard, as a method (type 2) of calculating an estimation value of BN-weak-hypothesis candidates other than the above expression (7), it is possible to use a weighted total value of all the learning samples of probability value of the event being equal to the label of the output node (output) as an estimation value. That is to say, as shown in the below expression (11), a probability value Pₕₗ (yₖ|fₖ) of the event yₖ being equal to the label of the output node (output) of the Bayesian network for the feature-quantity vector fₖ of the k-th sample sₖ is calculated. Further, weighting factor wₖ^{s} is multiplied for each sample, and the total value of the weighted probability value for all the learning sample T is calculated to be the estimation value E (hₗ^{BN}) of the BN-weak-hypothesis candidate hₗ^{BN}. Note that in the below expression (11), a total number of the samples sₖ of all the learning samples T is assumed to be m.

$${E}_{T , {w}^{s}}^{type 2} ( {h}_{l}^{BN} ) = {\sum }_{k = 1}^{m} {w}_{k}^{s} \cdot {P}_{{h}_{l}} ( {y}_{k} \vert {f}_{k} ) \qquad ( 11 )$$

Alternatively, as a method (type 3) of calculating an estimation value of BN-weak-hypothesis candidates other than the above expression (7), as shown in the below expression (12), it is possible to calculate the estimation value E (hₗ^{BN}) of the BN-weak-hypothesis candidate hₗ^{BN} using information-amount reference, such as BIC, AIC, etc. Thereby, it is possible to use an index indicating how correctly the structure of the BN-weak-hypothesis candidate hₗ^{BN} evaluates all the learning samples.

E_{T,w}_{^{s}}^{type3}(hₗ^{BN})=score_{B}(T_{w}_{^{s}},hₗ^{BN})=P(T_{w}_{^{s}}|hₗ^{BN}) (12)

Whichever of the above expressions (7), (11), and (12) is used, in order to calculate the estimation value E (hₗ^{BN}) of the BN-weak-hypothesis candidate hₗ^{BN}, it is necessary to have two kinds of parameters, namely, threshold values θₗ^{j}* of individual feature-quantity nodes j and the conditional probability distribution Dₗ* necessary for probability estimation of the output node when values are input into all the feature-quantity nodes. If the individual feature-quantity nodes are all discrete nodes, the threshold values θₗ^{j}* of the individual feature-quantity nodes can be described as Table 1, and the conditional probability distribution Dₗ* can be described as a conditional probability table as shown in Table 2 (described before).

Before calculating the estimation value E (hₗ^{BN}) using any one of the above expressions (7), (11), and (12) in step S45, it is necessary to have calculated the two kinds of parameters, namely, the threshold values θₗ^{j}* of the individual feature-quantity nodes j and the conditional probability distribution Dₗ* in step S44. In the same manner as general boosting, the above values can be calculated in accordance with, for example, the following expression (13) so that the estimation value E (hₗ^{BN}) of the individual BN-weak-hypothesis candidate hₗ^{BN} becomes the maximum.

$$\{ {θ}_{l}^{j *} , {D}_{l}^{*} \} = arg { max}_{\{ {θ}_{l}^{j *} , {D}_{l}^{*} \}} {E}_{T , {w}^{s}} ( {h}_{l}^{BN} ) \qquad ( 13 )$$

In the above expression (13), the threshold values of the individual feature-quantity nodes can be obtained by combining all the feature-quantity nodes and making a full search. Also, the conditional probability distribution can be obtained using a general BN conditional probability distribution algorithm.

The learning of the parameters of the BN-weak-hypothesis candidate hₗ^{BN} in step S44 and the calculation of the estimation value E (hₗ^{BN}) of the BN-weak-hypothesis candidate hₗ^{BN} in step S45 are carried out for all the L BN-weak-hypothesis candidates created in sequence in step S42.

And when the calculation of the estimation values E (hₗ^{BN}) for all the BN-weak-hypothesis candidate hₗ^{BN} is completed (Yes in step S46), the BN-weak-hypothesis candidate having the highest estimation value among these is selected as the BN weak hypothesis to be used for the n-th weak discriminator 21-n (step S47) (note that n is an integer from 1 to L, and corresponds to the number of repetitions in the processing loop).

Next, in the same manner as general boosting, the BN-weak-hypothesis weight αₙ to be given to the weak discriminator 21-t is set on the basis of the estimation value of the selected BN-weak-hypothesis candidate (step S48). Assuming that the estimation value of the BN weak hypothesis selected as the n-th weak discriminator 21-n is eₙ, for example, in the case of AdaBoost, the BN-weak-hypothesis weight αₙ can be calculated using the following expression (14).

αₙ=½ ln(eₙ/1−eₙ) (14)

The BN weak hypothesis selected in step S47 and, the BN-weak-hypothesis weight calculated in step S48 are stored one after another as a boosting learning result.

The selection of the BN weak hypothesis to be used as a discriminator 21-n and the weak-hypothesis weight calculation processing S42 to S48, as described above, are repeatedly performed until the total number n of the selected BN weak hypotheses reaches a predetermined number (step S49).

Here, in order to select the next BN-weak hypothesis, when returning to the creation processing (step S42) of the BN-weak-hypothesis candidate again (No in step S49), the sample weight wₖ of each sample sₖ included in the learning sample T is updated (step S50) on the basis of the BN weak hypothesis adopted in step S7. For example, as shown in the following expression (15), it is possible to calculate a sample weight on the basis of the feature vector fₖ and the discrimination label yₖ for each sample sₖ, and the discrimination result hₜ (fₖ) on the individual samples sₖ.

$${w}_{n + 1 , k} = {w}_{n , k} exp ( - {α}_{n} {y}_{k} {h}_{n} ( {f}_{k} ) ) \\ {w}_{n + 1 , k} = {w}_{n + 1 , k} / {\sum }_{k}^{ } {w}_{n + 1} \qquad ( 15 )$$

In this regard, in the above description of the boosting learning using a Bayesian network as weak hypotheses, it is assumed that all the feature-quantity nodes have discrete values (binary values). However, the gist of the present invention is not necessarily limited to this. For example, there is no problem if a part of or all of the feature-quantity nodes are multi-valued nodes or continuous nodes as long as the probability of the output node can be estimated.

Also, a boosting algorithm that can be applied to the present invention is not limited to AdaBoost (Discrete AdaBoost). For example, as shown in the following expression (16), the weak hypotheses output continuous values so that a boosting algorithm, such as Gentle Boost or Real Boost, etc., can also be applied to the present invention.

hₗ^{BN}(fₖ)=Pₕ_{ₗ}(1|fₖ) (16)

By the boosting learning in accordance with the processing procedure shown in FIG. 4, a requested number of weak discriminators including BN weak hypotheses can be obtained, and it is possible to discriminate an opinion sentence using the BN-weak-hypothesis weights of the individual weak discriminators.

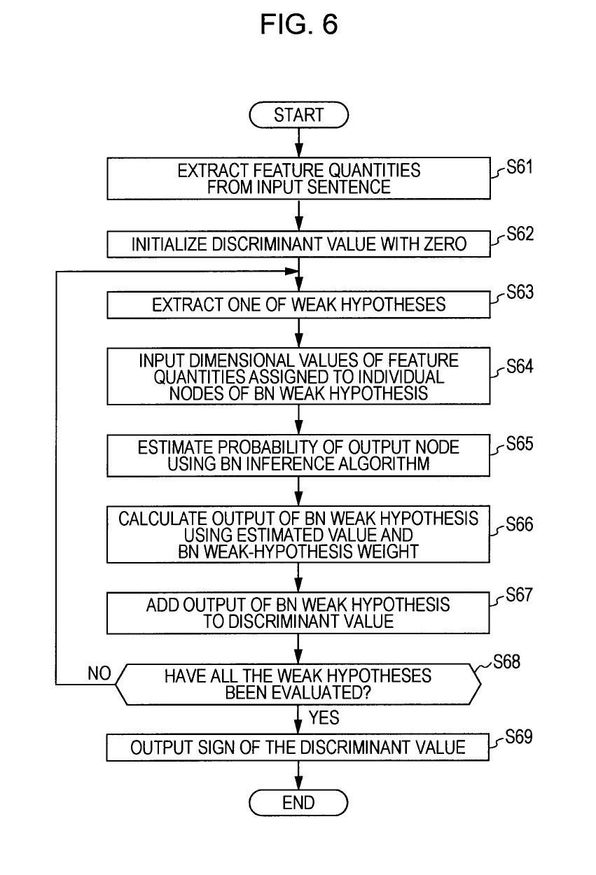

FIG. 6 illustrates a processing procedure, by a flowchart, for discriminating an opinion sentence using boosting with a Bayesian network as a weak hypothesis. As a learning result of the above-described boosting, it is assumed that the same number of the BN weak hypotheses as that of weak discriminators 21-1 . . . , and the weights of the BN weak hypotheses thereof are stored.

First, the feature-quantity extraction section 12 extracts feature-quantity vectors from an input sentence to be an object of discrimination (step S61).

Next, the discriminator 13 initializes the discriminant value with 0 (step S62).

Here, one of BN weak hypotheses obtained by the boosting learning is extracted (step S63).

Next, among the feature-quantity vectors extracted in step S61, the feature-quantity dimension numbers allocated to the individual feature-quantity nodes of the Bayesian network expressing the BN weak hypotheses are input (step S64).

Next, the probability of the output node is estimated using a Bayesian network inference algorithm (step S65). And an output of the BN weak hypotheses is calculated by multiplying the estimated probability value and a weight corresponding to the BN weak hypothesis (step S66). And the output of the BN weak hypotheses calculated in step S66 is added to the discriminant value (step S67).

If the feature-quantity nodes of the n-th BN-weak-hypothesis candidate hₙ^{BN} extracted in step S63 are all discrete nodes, in the Bayesian network inference algorithm in step S65, a comparison is made between the input feature-quantity dimension value and the corresponding threshold values θₙ^{j}* for each feature-quantity node j. And it is possible to obtain the output label (the probability that an input sentence is an opinion sentence) indicated by the combination of comparison results for each feature-quantity node j by referring to the conditional probability table Dₙ*. The output of the BN weak hypotheses is obtained by multiplying the value of the output label and the weight of the BN weak hypotheses held by the BN weak hypotheses hₙ^{BN}, and then the output value is added to the discriminant value.

Such output calculation of the BN weak hypotheses and addition to the discriminant value are carried out for all the BN weak hypotheses obtained by boosting learning (step S68). And the sign of the final discriminant value obtained indicates whether the input sentence is an opinion sentence or a non-opinion sentence. This sign is output as a discrimination result (step S69), and this processing routine is terminated.

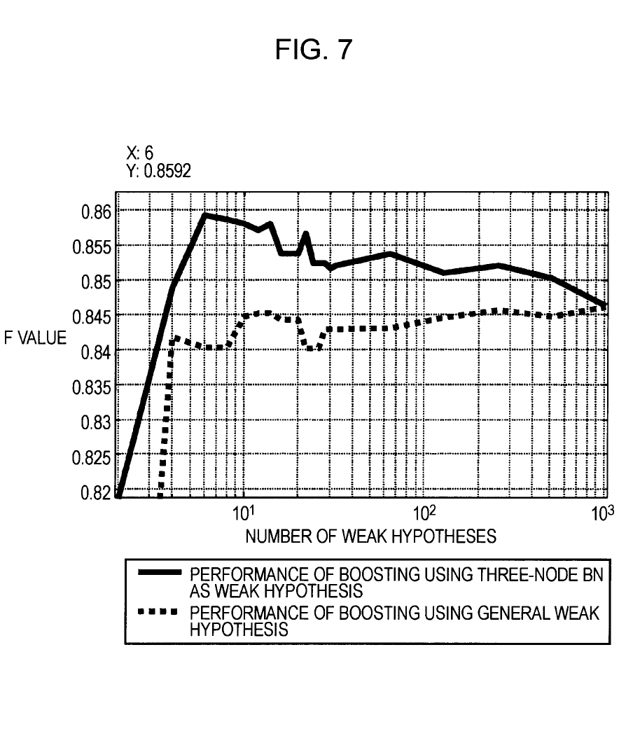

FIG. 7 shows, by a solid line, a relationship between the number of weak hypotheses and performance in the case of applying the present invention to text discrimination. Note that this is performance of boosting with a Bayesian network including two feature-quantity nodes and one feature-quantity node, that is to say, three nodes in total. In the figure, a relationship between the number of weak hypotheses and performance in general weak hypotheses, in which threshold-value discrimination is performed independently for each feature-quantity dimension, is also shown by a dashed line for comparison.

As shown in the figure, in general weak hypotheses, the F value is not improved so much even if the number of weak hypotheses becomes 1024. In this regard, the present inventor performed experiments until the number of general weak hypotheses goes to 8192. However, the F value does not exceed 0.8592. In contrast, in the case of using a Bayesian network for weak hypotheses, it is possible to ensure good text discrimination performance with only about 6 weak hypotheses. In short, by the present invention, it is said that sufficiently high performance can be obtained with a smaller number of weak hypotheses than a related-art algorithm.

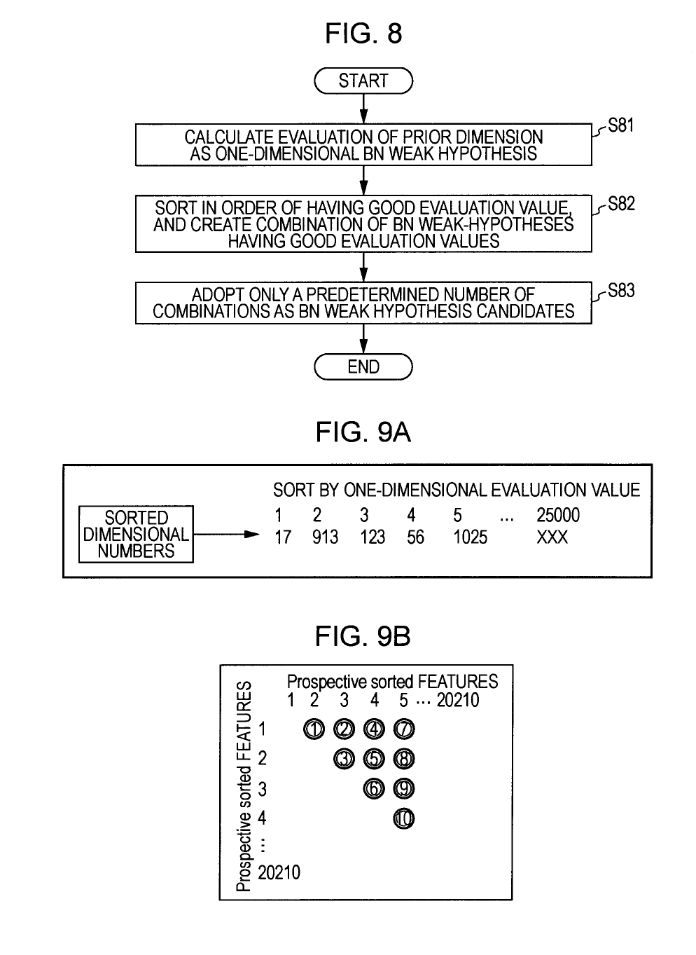

In this regard, even if the network structure of the BN-weak-hypothesis candidate is limited as shown in FIG. 5A and FIG. 5B, when the number of dimensions d of feature quantities is large, the number of candidates L (=_{d}C₂ (=d (d−1)/2)) of weak hypotheses also becomes large. FIG. 8 illustrates, as a flowchart, processing procedure for reducing the number of BN weak hypotheses without decreasing the evaluation value of BN weak hypothesis having the best evaluation among BN weak hypothesis candidates.

First, in the same manner as general boosting algorithm, assuming that one weak hypothesis is provided for each one feature-quantity dimension, the estimation value of one-dimensional weak hypotheses for each dimension is calculated (step S81).

Next, the weak-hypothesis candidate is sorted in sequence in descending order of estimation value of one-dimensional weak hypotheses, and a combination of the weak-hypothesis candidates having a good estimation value is created (step S82). FIG. 9A illustrates a state in which one-dimensional weak hypotheses for each dimension is sorted in accordance with the estimation value.

And only a predetermined number of combinations are selected as weak-hypothesis candidates for the number of feature-quantity dimensions necessary of BN weak hypotheses in descending order of one-dimensional weak-hypothesis-estimation value (step S83). FIG. 9B illustrates a state in which up to 6 combinations are used when feature-quantity two-dimensional BN weak hypothesis candidate is created.

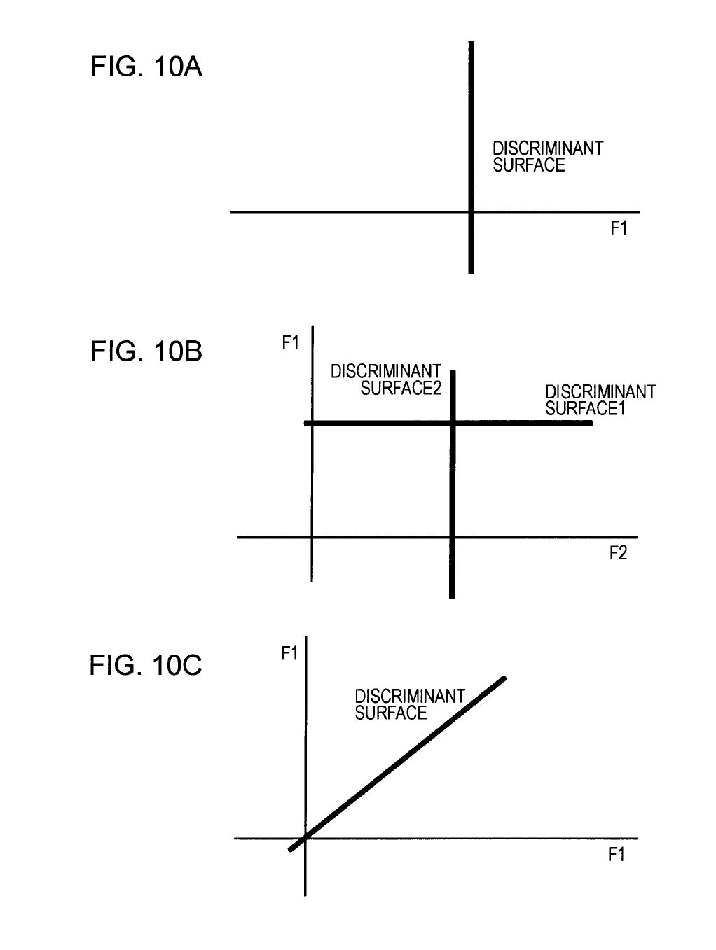

As shown in FIG. 10A, a weak hypothesis with one-dimensional feature quantity simply determines whether a feature quantity having a specific dimension (F1) exceeds a threshold value or not (that is to say, on which side of a discriminant surface in space the feature quantity of the object of discrimination exists in the figure), and thus the discrimination ability is generally low. In contrast, for example, as shown in FIG. 5A, if a Bayesian network is used as a weak hypothesis, even in the case of a relatively simple network structure including three nodes, namely, feature-quantity nodes corresponding to two-dimensional feature quantities and an output node corresponding to a discrimination result, as shown in FIG. 10B, the feature quantities of the object of discrimination are compared with the discriminant surfaces 1 and 2 corresponding to the feature quantities of the individual dimensions, and thereby the discrimination ability in a weak-hypothesis level is superior. Accordingly, with similar performance, it is possible to reduce the number of boosting weak hypotheses using BN weak hypothesis as in the case of the present invention.

On the other hand, there is a method of discrimination in which a feature-quantity difference is used as a weak hypothesis as described in the above-described Japanese Unexamined Patent Application Publication No. 2005-157679. However, in the method, a determination is simply made of whether the difference F1−F2 between the two feature quantities F1 and F2 exceeds a threshold value or not, that is to say, on which side of the discriminant surface in a discriminant space as shown in FIG. 10C, the feature quantity exists, and thus a discrimination ability is generally low. In contrast, in a method of discrimination using a Bayesian network as a weak hypothesis, even in a simple network structure as shown in FIG. 5A, the discriminant surfaces 1 and 2 corresponding to the feature quantities of the individual dimensions are provided as shown in FIG. 10B, and thus the discrimination ability in a weak-hypothesis level is superior. Accordingly, compared with a method of discrimination using a feature-quantity difference as a weak hypothesis, with a similar performance, it can be said that the number of boosting weak hypotheses can be reduced using a BN weak hypothesis as in the present invention.

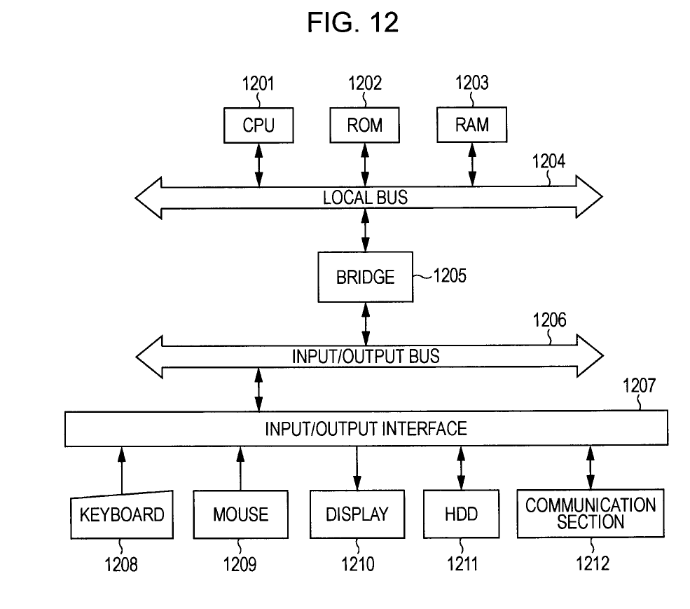

In this regard, it is possible to achieve a text discrimination apparatus 10 according to the present invention by implementing a predetermined application on an information apparatus, such as a personal computer (PC), etc., for example. FIG. 12 illustrates a configuration of an information apparatus.

A CPU (Central Processing Unit) 1201 performs programs stored in a ROM (Read Only Memory) 2 or a hard disk drive (HDD) 1211 under a program execution environment provided by an operating system (OS). For example, it is possible to achieve boosting learning processing using a Bayesian network as a weak hypothesis as described above, and boosting discrimination processing using a Bayesian network as a weak hypothesis by the CPU 1201 performing a predetermined program.

The ROM 1202 permanently stores the program code of POST (Power On Self Test), BIOS (Basic Input Output System), etc. The RAM (Random Access Memory) 1203 is used for loading the program stored in the ROM 1202 and the HDD (Hard Disk Drive) 1211 when executed by the CPU 1201, and for temporarily storing working data of the program being executed. These are mutually connected through a local bus 1204, which is directly connected to the CPU 1201.

The local bus 1204 is connected to an input/output bus 1206, such as a PCI (Peripheral Component Interconnect) bus, etc., through a bridge 1205.

A keyboard 1208, and a pointing device 1209, such as a mouse, etc., are input devices operated by a user. The display 1210 includes a LCD (Liquid Crystal Display), or a CRT (Cathode Ray Tube), etc., and displays various kinds of information by a text and an image.

The HDD 1211 is a drive unit that contains a hard disk as a recording medium, and drives the hard disk. The hard disk is used for storing programs executed by the CPU 1201, such as an operating system, various applications, etc., and data files, etc.

For example, applications, such as learning processing by boosting using a Bayesian network as a weak hypothesis, discrimination processing by boosting using a Bayesian network as weak hypotheses can be installed in the HDD 1211. Also, a plurality of BN weak hypotheses learnt in accordance with the processing procedure shown in FIG. 4 and weighting factors of the individual BN weak hypotheses can be stored in the HDD 1211. Also, it is possible to store learning samples T used for the learning processing for boosting in the HDD 1211.

The communication section 1212 is a wired or wireless communication interface for mutually connecting the information apparatus to a network, such as a LAN (Local Area Network), etc. For example, it is possible to download an application, which performs learning processing by boosting using a Bayesian network as weak hypotheses and discrimination processing of the boosting using a Bayesian network as weak hypotheses, from an external server (not shown in the figure) to the HDD 1211 through the communication section 1212. Also, it is possible to download a plurality of BN weak hypotheses to be used for the discrimination processing of boosting and the weighting factors of individual BN weak hypotheses from an external server (not shown in the figure) to the HDD 1211 through the communication section 1212. Alternatively, it is possible to supply a plurality of BN weak hypotheses and weighting factors of the individual BN weak hypotheses that have been allowed to be obtained from the learning processing on the information apparatus to an external host (not shown in the figure) through the communication section 1212.

The present application contains subject matter related to that disclosed in Japanese Priority Patent Application JP 2009-124386 filed in the Japan Patent Office on May 22, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A discrimination apparatus comprising:
a feature-quantity extraction section extracting a feature quantity from an object of discrimination; and
a discriminator including a plurality of weak discriminators expressed as a Bayesian network having each node to which a corresponding one of two or more of the feature quantities input from the feature-quantity extraction section is allocated and a combiner combining individual discrimination results of the object of discrimination by the plurality of weak discriminators.

2. The discrimination apparatus according to claim 1,
wherein the discriminator uses an inference probability of a discrimination-target node of the Bayesian network with weak-hypotheses as an output of the weak hypotheses.

3. The discrimination apparatus according to claim 1,
wherein BOW (Bag Of Words) or other high-dimensional feature-quantity vectors are used for the object of discrimination, and
the weak discriminator includes a Bayesian network having the feature quantity of a predetermined number of dimensions or less as each node out of high-dimensional feature-quantity vectors extracted by the feature-quantity extraction section.

4. The discrimination apparatus according to claim 1,
wherein a text is included in the object of discrimination, and the discriminator carries out binary discrimination on whether an opinion sentence or the other kinds of text.

5. The discrimination apparatus according to claim 1,
wherein, on the basis of whether an inference probability of a discrimination-target node of the weak-hypothesis Bayesian network is greater than a predetermined value, the discriminator determines an error of the weak hypothesis.

6. The discrimination apparatus according to claim 1,
further comprising a learning section learning weak hypotheses to be used by the plurality of weak discriminators, respectively, and weight information of the individual weak hypotheses by prior learning using boosting.

7. The discrimination apparatus according to claim 6,
wherein the learning section reduces a number of weak-hypothesis candidates by limiting a number of feature-quantity dimensions used by one weak hypothesis.

8. The discrimination apparatus according to claim 6,
wherein the learning section calculates an evaluation value of one-dimensional weak hypothesis of each dimension on the assumption that a number of feature-quantity dimensions used for one weak hypothesis is 1, and creates a weak hypothesis candidate by combining necessary number of feature-quantity dimensions for a weak hypothesis in descending order of the evaluation value of the dimension.

9. A method of discrimination, comprising the steps of:
extracting a feature quantity from an object of discrimination; and
discriminating the object of discrimination by a plurality of weak hypotheses expressed as a Bayesian network having each node to which a corresponding one of two or more of the feature quantities obtained by the step of extracting a feature quantity is allocated, and combining individual discrimination results of the object of discrimination by the plurality of weak hypotheses.

10. A computer program causing a computer to function as a discrimination apparatus comprising:
a feature-quantity extraction section extracting a feature quantity from an object of discrimination; and
a discriminator including a plurality of weak discriminators expressed as a Bayesian network having each node to which a corresponding one of two or more of the feature quantities input from the feature-quantity extraction section is allocated and a combiner combining individual discrimination results of the object of discrimination by the plurality of weak discriminators.
